(19) United States
(12) Patent Application Publication
(10) Pub. No.: US 2002/0138321 A1
(43) Pub. Date: Sep. 26, 2002

(54) Fault tolerant and automated computer software workflow

(75) Inventors: Huey-Shin Yuan, Cupertino, CA (US); John F. Arackaparambil, San Carlos, CA (US); Venu Narra, San Jose, CA (US); Prakash M. Kulkarni, San Ramon, CA (US)

Correspondence Address: PATENT COUNSEL, APPLIED MATERIALS, INC., Legal Affairs Department, P.O. BOX 450A, Santa Clara, CA, 95052, US

(73) Assignee: Applied Materials, Inc.

(21) Appl. No.: 09/811,667

(22) Filed: Mar. 20, 2001

(51) Int. Cl. G06F 17/60

(52) U.S. Cl. 705/8

(57) ABSTRACT

An automated workflow system, method and medium for implementation of manufacturing activities in a manufacturing facility are described. At least some embodiments of the present invention include a workflow software component that is configured to execute a number of tasks to be performed automatically and configured to retry a predetermined number of times when one of the plurality of tasks fails to be executed.

### FIELD OF THE INVENTION

The present invention relates to computer software workflow. More specifically, the present invention relates to a computer-implemented workflow system, method and medium that automatically executes manufacturing processes without being affected by errors or disruptions.

### BACKGROUND OF THE INVENTION

Workflow is a set of tasks that are performed in series or in parallel in order to achieve a goal. In conventional workflow, each task may be performed manually by a person or automatically by a computer/machine. As examples of its use, manufacturing facilities can use workflow to direct its machines and technicians to manufacture goods. In another example, insurance companies regularly use workflow to direct insurance adjusters to fill out claim forms.

As the underlying activities (e.g., manufacturing processes) become more complex, workflow used for directing such activities has become proportionally complex as well. Such an exemplary workflow in the context of a manufacturing facility and its computer software (the “control software”) to control and manage the facility is described below by first describing an exemplary manufacturing facility and then describing its exemplary control software.

As an example of a manufacturing facility, FIG. 1 illustrates a microelectronic device fabrication system (101) that includes assembly lines 102 and 110. Each assembly line includes manufacturing machines such as a number of etchers 103, 105, 111, 113 and layer depositors 107, 109, 115, 117. Fabrication system 101 also includes one or more controllers 119, 121. The letter “L” for etcher 105 in assembly line 1, “M” for layer depositor 109 in assembly line 1, “N” for etcher 113 in assembly line Q. “O” for layer depositors 117 in assembly line Q, “P” for controller 121 and “Q” for assembly line 110 represent different integer numbers to illustrate the utilization of any number of the designated items.

An etcher is a manufacturing machine configured to etch a layer or layers of a substrate during manufacture of microelectronic devices. Similarly, a layer depositor is a machine configured to deposit a layer or layers on a substrate during manufacture of electronic devices. Assembly line machines (e.g., etchers, depositors) and controllers include a computer or computer like device that includes a processor, a read-only memory device and a random access memory.

Exemplary control software for proper operation of the above described assembly lines may be the FAB 300 V. 1.0, developed by Consilium, Inc. (an Applied Materials company) of Mountain View, Calif. The FAB 300 is an integrated suite of microelectronic device fabrication management software that controls and automates real-time operations of fabrication equipment, (e.g., fabrication system 101) including those using 300 mm wafers. The FAB300 is a software component based system that includes application components to coordinate and optimize materials, equipment, quality information, documents, scheduling, dispatching, yield and other elements of the computer-integrated manufacturing environment.

As a part of the control software, a conventional workflow engine may direct the assembly lines and their manufacturing machines to produce microelectronic devices. A workflow engine is computer software that automatically executes or instructs a technician to execute tasks defined in workflow. In particular, a workflow engine may instruct technicians, machines and various components of the control software to process a batch of materials (e.g., unprocessed wafers) using etchers and depositors.

One of the considerations in operating the above described manufacturing facilities is that they must be financially competitive. In order to remain competitive, many manufacturing facilities have opted to operate twenty four hours a day, seven days a week and three hundred sixty five days a year. Under such a full operation mode, any down time of the facilities is undesirable. However, when using a conventional workflow engine, events such as power interruptions cause down times. This is because when there is a disruption such as power interruption, there is a short period of time (e.g., a split second to few seconds) before a backup power system thereof is activated. After such an interruption, the conventional workflow engines cannot be restarted automatically. They require intervention by technicians because conventional workflow engines are not designed to restart automatically after an interruption. This, in turn, requires the technicians to be available at the facility whenever the facility is operating or for the technicians be available to be called at any time for any minor power interruptions. Either one of these options increases the overall operating cost and does not significantly reduce the down times.

Another aspect in maintaining the competitiveness is the ability to expand and upgrade the assembly line machines. However, the conventional workflow engines require specialized interfaces such that any new machine or computer program that does not meet the specialized interfaces would have be reconfigured and/or modified so that they may receive instructions from and function as directed by the respective workflow engines. This shortcoming of the conventional workflow engines often causes delays and cost overruns in expanding existing manufacturing facilities.

### SUMMARY OF THE INVENTION

Accordingly, embodiments of the present invention provide a computer-implemented workflow system, method and medium. At least some embodiments of the present invention include a workflow software component that is configured to execute a number of tasks to be performed automatically and configured to retry a predetermined number of times when one of the number of tasks fails to be executed.

### BRIEF DESCRIPTION OF THE DRAWINGS

The detailed description of a preferred embodiments of the present invention showing various distinctive features may be best understood when the detailed description is read in reference to the appended drawing in which:

FIG. 1 is a schematic representation of exemplary manufacturing assembly lines;

FIG. 2 is a schematic representation of various servers of a workflow software component according to at least some embodiments of the present invention;

FIG. 3 is a flow chart of the life cycle of a workflow software component according to at least some embodiments of the present invention;

FIG. 4 is a diagram illustrating a graphical user interface to be used by a modeler according to at least some embodiments of the present invention;

FIG. 5 is a flow chart of state transitions of a task being executed according to at least some embodiments of the present invention;

FIG. 6 is a schematic representation of various servers and their activities when a task is executed according to at least some embodiments of the present invention;

FIG. 7 is a schematic representation of various servers and their activities when a long running service is locked to be executed according to at least some embodiments of the present invention;

FIG. 8 is schematic representation of various servers and their activities when a long running service fails to lock according to at least some embodiments of the present invention;

FIG. 9 is a block diagram of a computer system that includes a workflow software component according to at least some embodiments of the present invention; and

FIG. 10 is a diagram illustrating a floppy disk that may store various portions of the software according to at least some embodiments of the present invention.

### DETAILED DESCRIPTION OF THE INVENTION

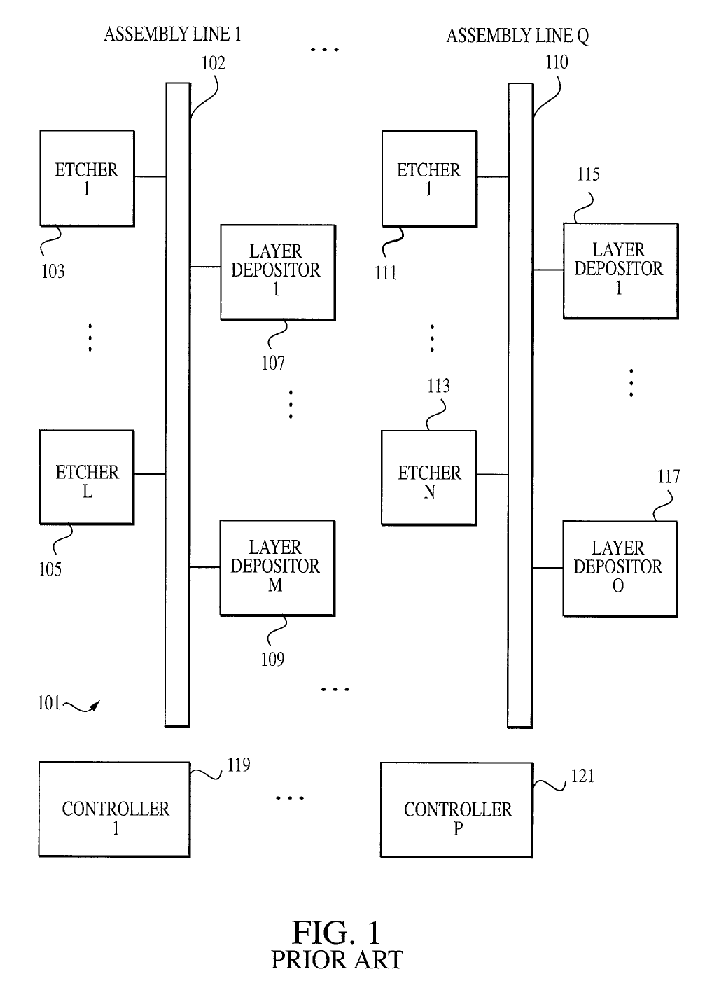

Embodiments of the present invention (e.g., a workflow software component are described in the context of manufacturing processes of a manufacturing system such as microelectronic device fabrication assembly lines as described above in FIG. 1 and its control software (e.g., FAB 300). However, it should be understood that embodiments of the present invention may be used in other systems in which a fully automated and fault tolerant workflow software component may be required. Moreover, it should be also noted that the words “step” and “task” are used interchangeably herein. Either word may refer to an automatic step that a computer or machine may perform under the direction of the workflow software component of the present invention.

The automated steps are the steps that can be performed by a software object residing in a computer or a machine that includes computer-like functions (e.g., executing computer programs). More specifically, in the control software, there can be a number of registered software objects that can each perform one or more specific tasks. For instance, a software object may be configured to check the status of a machine, trigger a manufacturing machine to run a self diagnostic procedure, trigger an etcher to etch away a layer from a wafer, trigger a depositor to deposit a layer on a wafer, etc. Another exemplary software object may be configured to cause a material handling machine to move a batch of materials from one machine to another. These software objects (with their corresponding registered Application Program Interfaces, APIs) may then be used to assist in implementing the automated steps as directed by the workflow software component. Because, in at least some embodiments of the present invention, these objects provide services that are considered to be not internal to the workflow software component of the present invention, they are also referred as objects that provide “external services.” (Of course, it should be understood that various embodiments of the present invention do contemplate situations where one or more of such objects are an integral part of the present invention, e.g., part of the workflow software component.

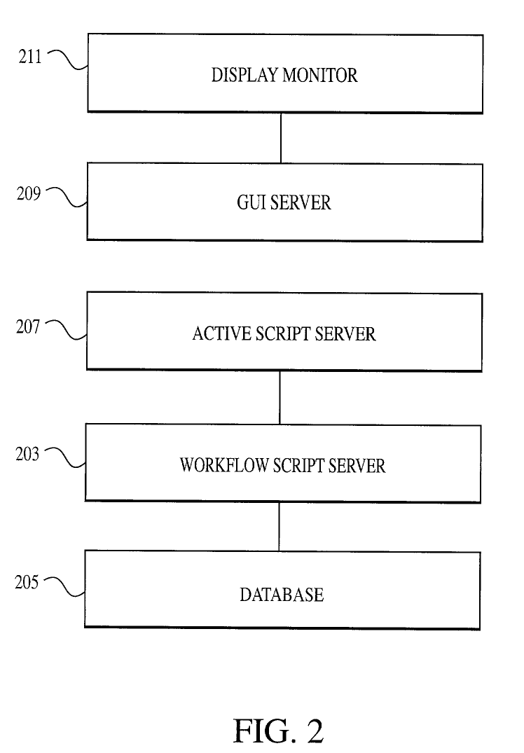

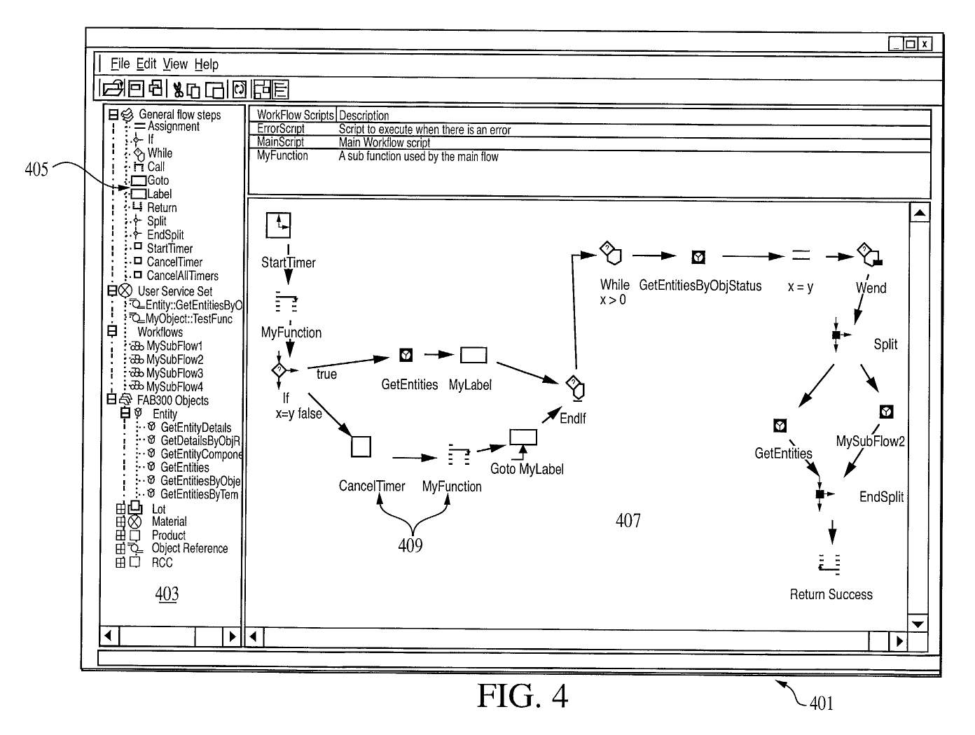

Now turning to describe the workflow software component, software components and servers used with at least some embodiments of the workflow software component are described in conjunction with FIG. 2. Referring now to FIG. 2, a workflow script server 203 is shown, which is configured to store and retrieve workflow scripts to/from a database 205. A workflow script is a script that includes automatic steps to be executed and processing logic associated therewith. In at least some embodiments of the present invention, a workflow script may not include any manual tasks. Database 205 can be implemented using standard database management systems (e.g., those from Oracle Corporation of Redwood Shores, Calif.). An active script server 207 is configured to instantiate (i.e., spawn an instance of) one or more active script objects (e.g., registered software objects, as mentioned above). An active script object instantiated by active script server 207 contains information relating to a workflow script retrieved from database 205 using workflow script server 203. A GUI (Graphical User Interface) server 209 is configured to display, on a computer display monitor 211, a modeling GUI (e.g., as shown in FIG. 4, to be described later) which graphically displays the retrieved workflow script. In at least some embodiments of the present invention, workflow script server 203 can be an MTS (Microsoft Transaction Server) component, active script server 207 can be an in-proc COM object, and GUI server 209 can be implemented using ActiveX controls. It should be noted that other software implementation tools/environments may be utilized as well (e.g., Java Beans and X-Windows).

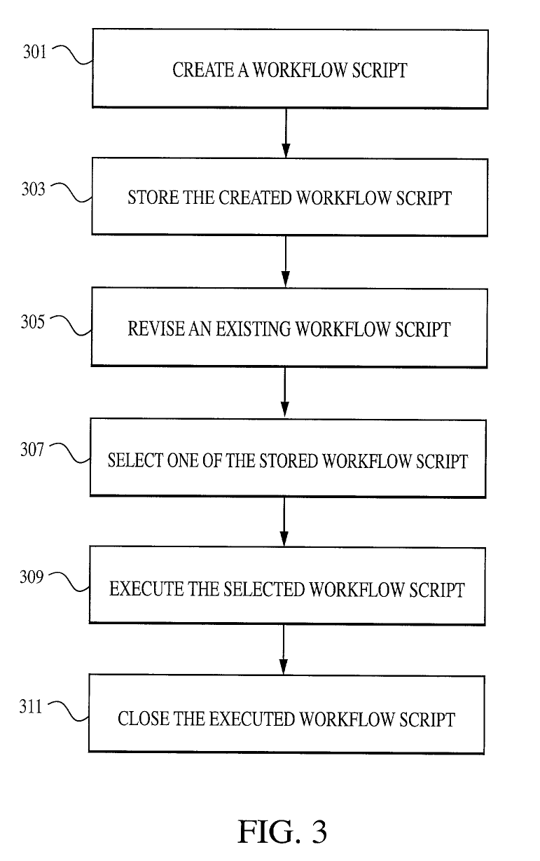

Now referring to FIG. 3, specific exemplary aspects of at least some embodiments of the present workflow software component are now described. More particularly, FIG. 3, depicts an exemplary methodology for the creation and usage (i.e., “lifecycle”) of workflow scripts. Referring now to the flowchart of FIG. 3, a workflow script is created (step 301) using a GUI (e.g., as shown in FIG. 4, to be described later). The created workflow script is then stored (step 303) into database 205, possibly with other previously created workflow scripts. At least some embodiments of the present invention contemplate that the stored workflow scripts may be revised (step 305) at a later time. A stored workflow script is then selected (step 307) among other stored workflow scripts (e.g., in order to accomplish a set of manufacturing processing steps) by a user. An example of a set of manufacturing processing steps may include data collection, analysis of the collected data and processing a lot of wafers based on the analysis (e.g., etching, depositing, etc.). The selected workflow script is then executed (step 309) according to the scripted tasks and processing logic defined therein. After completing the execution of the tasks, the workflow script is then closed (step 311). The above steps of FIG. 3 are described below in detail.

In the creating workflow script step 301, a user (hereinafter a modeler in the discussion of creating a workflow script) may include (e.g., enter) any number of steps into the workflow script being created. FIG. 4 illustrates a GUI 401 for creating workflow scripts in at least some embodiments of the present invention. In particular, a menu field 403 includes a number of sub-menu fields such as a logic option field 405 that includes a list of workflow logic options (e.g., if, while, goto). GUI 401 is configured such that the modeler may select the flow logic options (and other options in menu field 403) and drop them into a workflow script definition field 407.

The selected and dropped flow logic options are then turned into a workflow diagram having icons 409 and flow directions. The flow directions are represented by arrows to indicate the flow of the logic. Each icon represents a step to be executed by making a call to an external service (e.g., a software object). When selected, an icon is also configured to initiate a pop-up window that displays information pertaining to the object represented by the icon. In other words, GUI 401 is integrated with the APIs of the external services such that the objects can be represented as icons in workflow script definition field 407. A workflow script is thus created based on the workflow diagram created by the modeler.

In at least some embodiments of the present invention, any GUI configured to allow steps and processing logic to be drawn, generate corresponding scripts and be integrated with the APIs of the external services is sufficient for the purposes of the present invention. An exemplary alternative GUI for creating workflow scripts is Visio™ developed by Microsoft Corporation of Redmond, Wash.

The steps (e.g., objects represented by the icons) in the workflow script can represent external services configured to provide the following exemplary services: a short running (SR) service; a Graphical User Interface (GUI) service; a long running (LR) service. More specifically, an example of an “SR service” is a logging in event (which, typically, is “short” in duration) without the use of a GUI. Since SR services are executed as soon as they are requested, SR services are referred to as synchronous services. A “GUI service” displays GUIs, e.g., displaying GUI 401, and receives entries made by a person using the GUIs. An example of an “LR service” is calling an external service that requires tracking the progress of the service over a certain length of time (e.g., few seconds to minutes or longer). It should be noted that the GUI service can be considered as a species of an LR service. One difference between an LR service and an SR service is that an LR service includes a return address, whereas an SR service does not. This allows an LR service to return execution results and other relevant information to the return address after the completion of the requested service.

Once the modeler completes creating a workflow diagram using various features described above, active script server 207 is configured to validate and parse the syntax of the workflow script being generated based on the workflow diagram. A successful parse of the workflow diagram creates a workflow script that includes a list of execution steps and their associated workflow logic. Active script server 207 then encapsulates the workflow script and may also encapsulate the workflow diagram. Subsequently, active script server 207 passes the encapsulated and parsed workflow script (and also the workflow diagram) to workflow script server 203. In turn, workflow script server 203 stores the encapsulated information to database 205.

Using the above described steps, a number of workflow scripts and their workflow diagrams can be stored into database 205. Subsequently, a user may select (step 307) one of the stored workflow scripts using an execution GUI (not shown) from a client. A client can be an automated process (e.g., a lot server that tracks a lot of wafers in a microelectronic device manufacturing processes) running on a computer or a machine that includes computer-like functions (e.g., executing computer programs).

In the execution step 309, for the selected workflow script, a job server is provided thereto. The job server is a software component configured to execute the tasks included in the selected workflow script. The job server can be an MTS component. More specifically, a job creation request is sent to the job server, which creates a process instance (e.g., job) as specified by the workflow to be executed. In other words, a job is an executing instance of the selected workflow script. Hence, a number of jobs can be instantiated from one workflow script. Subsequently, the workflow script is executed by the instantiated job. In turn, a pending task is created for each step as specified in the workflow script for which the job was instantiated.

A request to instantiated a job can be made externally (e.g., upon a request from a client) or internally (e.g., a nested job creation, a split instruction, etc) with respect to the workflow software component. A nested job creation refers to a situation in which a job is created within another job (e.g., a step in a workflow script calling another workflow script). A split instruction splits a job. The details of splitting a job is described later.

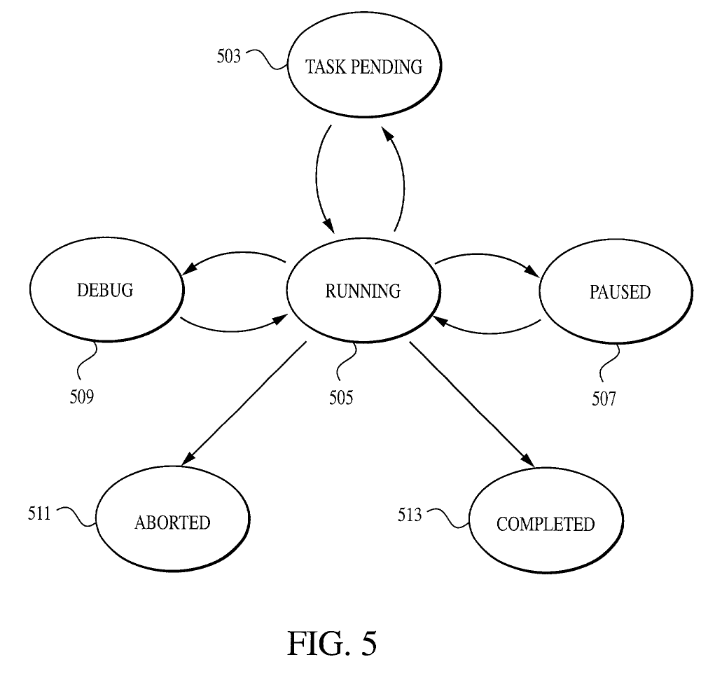

As noted above, when a job is being executed, each task as defined in the workflow script from which the job was instantiated is executed. Each task may undergo a number of different states while it is being executed. More specifically, FIG. 5 illustrates various exemplary states of a task being executed. In particular, the job server first creates a pending task, assigns a unique identification to the pending task (task-id) using a task processor to be described later and sends the pending task to a process controller server. The process controller server is a server that keeps track of various server activities and manages various resources of the workflow software component. The process controller server can be implemented using Windows 2000 Services, NT server or any other similar products.

Depending upon the availability of the process controller server, the pending task may be processed according to the defined logic associated with the task as specified in the workflow script from which the job was instantiated (state 505). In addition, the task may be paused (state 507) when the workflow script requires a pause explicitly or when a GUI or a long running service is called by the task. After the pause, the job server resumes running the paused task when a user requests for the resumption of the paused task or when the GUI or LR task is completed and the job server is notified of the task completion. The task may also put into a debug state (state 509) or may be aborted (state 511). In particular, abort state 511 can be entered by an external request or by a predefined script step. When the task is completed, the job server is put into a completed state 513. Subsequently, the job server executes the next task specified in the workflow script.

In order to more properly describe how tasks are executed, two more software servers are introduced here, in addition to the servers introduced above: a task initiator server and a task processor server. The task initiator server is configured to handle calling the task processor server to process a pending task and, upon return, to process any errors. As an example of handling an error, when an error causes the task processor server to fail to process a pending task, then the task initiator server can “rollback” and retry the failed task (by again calling the task processor to process the incomplete pending task). In general, the task process server performs the action required specified by the pending task. More specifically, the task process server is configured to handle the actual task execution by calling the specified external services. When the task is completed, the task process server forwards a request to the process controller server for the next task.

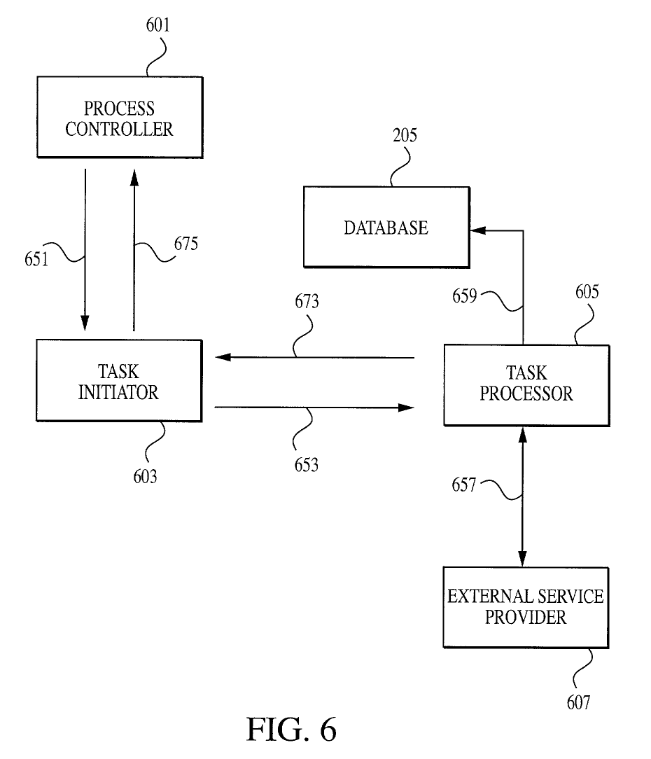

Now referring FIG. 6, this figure illustrates exemplary steps involved in executing a task using the servers described above. As a first step, a process controller 601 makes a call (e.g., a request) to a task initiator 603 to execute a task (step 651) among the pending tasks that process controller 601 received from the job server. In turn, task initiator 603 makes a call (e.g., a request) to a task processor 605 (step 653) to execute the task. Upon receiving the task, task processor 605 attempts to “lock” the task and its job before actually executing the task (step 655). A lock is a designation in database 205 that indicates that a specific task, identified by its task_id, is currently being executed. When more than one task processors attempt to lock the same task, one of them (e.g., the first task processor to attempt the lock) is allowed to lock the task, causing the other task processors time out after a predetermined time period (e.g., one or more seconds). Process controller 601, task initiator 603 and task processor 605 are objects instantiated by the process controller server, the task initiator server, and the task processor server, respectively.

After a successful lock, task processor 605 invokes the specified service on an external service provider 607 (step 657) that interfaces with the services provided by the registered objects (e.g., the external services) discussed above. (Also, consistent with what is mentioned above, at least some embodiment of the present invention contemplate that a “service provider” is used to provide services that can be thought of as internal (i.e., part of the present invention). Task processor 605 then updates job context and writes execution history into database 205 (step 659). The job context is data associated with processing a job such as task_id and whether or not the task identified by the task_id is currently being executed. The execution history is information relating to the status of a job, e.g., services completed, errors, etc.

When the task requesting an SR service is processed by task processor 605, the SR service is processed “synchronously.” In particular, an SR service is executed when it is requested and the resources (e.g., allocated memory, CPU time, locks on the tasks, etc.) of the workflow software component are held up until the SR service is completed. As for LR services, these services are processed asynchronously. More specifically, a task that requests an LR service is suspended and the resources of the workflow software component are freed until the LR service returns with a response (e.g., service completed, error encountered, user responded, etc.). In other words, task processor 605 is freed to execute the next pending task without waiting for the LR service to be completed.

A typical workflow script may include a series of SR services intermixed with LR services. Therefore, the process controller server processes SR services relatively quickly (e.g., synchronous executions) and suspends LR services until their completion (e.g., asynchronous executions). This feature advantageously reduces the load on the resources of the workflow software component.

In at least some embodiments of the present invention, task process 605 is configured to provide transaction services. More specifically, task processor 605 may commit (i.e., group together) a number of tasks and execute them using the same resources of the workflow software component as defined in the workflow script being executed. In other words, the tasks in one commit (i.e., in one group) are locked together until all the tasks in that commit have been completed. Thus, in these embodiments, rather than committing the resources of the workflow software component for executing one task at a time, a number of similar tasks can be executed at the same time. For example, a workflow script can be used to transfer data between manufacturing applications and corporate applications. In this example, the data volume to be transferred can be large, but the tasks are highly repetitive. The repetitive tasks are to read data from one system and update it on the other system. Task processor 605 can then commit and execute a certain number of transfers (e.g., fifty) at a time. This commit features is also integrated with GUI 401. In particular, the workflow modeler is allowed to put “commit” logic in between the data copy iterations. In this example, a commit instruction would be entered after transferring fifty objects of data. This feature advantageously allows the workflow software component to refresh the resources periodically.

After completion of the task to which it was attending, task processor 605 then deletes the pending task and generates the next pending task, and then broadcast the identification of the next task to process controller 601. Acknowledgements are then made by task processor 605 to task initiator 603 (step 673) and by task initiator 603 to process controller 601 (step 675).

While executing tasks as described above, a number of errors may occur. In considering possible errors, the errors can be categorizes into two categories. The first category is a transient error. A transient error is a temporary error in that, with the passing of time, the cause of the error may disappear. An example of the transient error is an electrical power interruption. When the electrical power supply is interrupted in a manufacturing facility, a backup power system is activated to provide electrical power to its assembly lines. However, there is often a delay of a fraction of a second to a few seconds before the backup power system is activated. This is because the backup power system must detect the power interruption first. However, in conventional workflow engines, the assembly lines may not be reactivated unless a technician intervenes. The second category of errors are hard errors that the passing of time would not remove the cause of the errors. For instance, when a script is incorrectly created to include a step that cannot be processed, then the error caused by such a step cannot be corrected by simply waiting.

In anticipation of these hard errors, GUI 401 is configured to allow a modeler to enter instructions to handle the occurrence of such hard errors. For instance, a modeler may specify that, in case of a hard error occurring at a certain step, the workflow software component may send an e-mail to a specified address with a specified message, send a message to a specified phone number (e.g., a pager), display a message so that a user may check for consistency in the workflow script, invoke debug state 509, etc.

In at least some embodiments of the present invention, when task processor 605 fails due to a transient error, then process controller 601 is configured to retry the task. In particular, process controller 601 accesses database 205 to retrieve pending processes (i.e., jobs that have been started but not completed by task processor 605). The pending processes are then retried by process controller 601 which makes requests to execute the pending tasks. The retry is repeatedly attempted up to a user configurable retry limit (e.g., 5, 10, 20, etc.). In some embodiments of the present invention, each time an attempt is made the interval between the retries are lengthened. For instance, the interval between the retry attempts may increase in certain multiples (e.g., five, ten, etc.) In this scenario, a second retry may be attempted after one CPU cycle of a first attempt. A third retry may then be attempted after five CPU cycles of the second retry. A fourth retry may then be attempted after twenty five CPU cycles of the third retry. The retry attempts could succeed/fail. If it fails after retrying up to the configurable retry limit, then task initiator 603 initiates error processing for the workflow script. In other words, this is treated as a hard error.

The following is another example of the transient error handling feature described above. Task initiator 603 may stop functioning after calling task processor 605 or before calling task processor 605 due to a transient error. Under these circumstances, process controller 601 receives a transient error message. Process controller 601 then retries the call on task initiator 603, up to the configurable retry limit. Assuming that the cause of the transient error disappeared wherein task initiator 603 starts to function again), then if task processor 605 has already completed the specific pending task, it returns an acknowledgement immediately to task initiator 603, and thence to process controller 601. The pending task is then removed from process controller 601. If task processor 605 has not executed the specific pending task, it then processes the pending task.

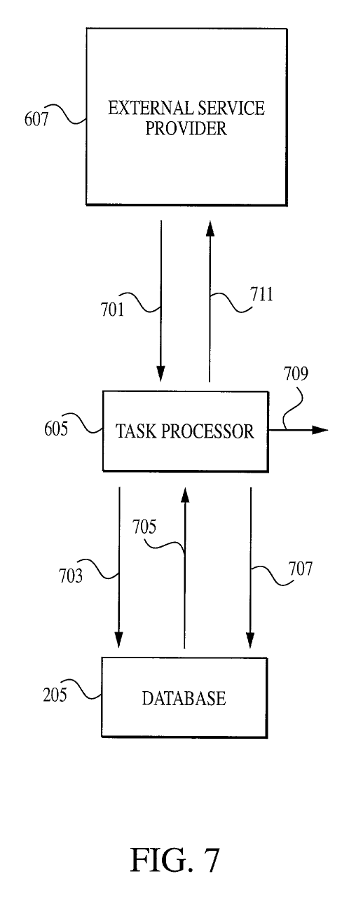

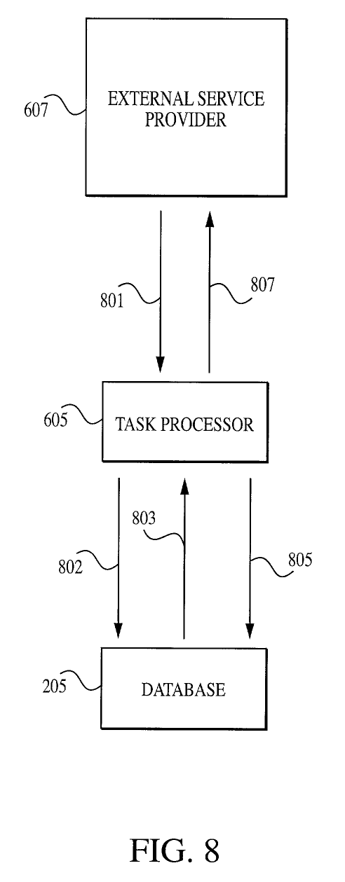

In another instance, process controller 601 may fail while processing a task. When process controller 601 starts up again, it retrieves a pending task from the workflow script from which the job being executed was instantiated. If the task prior to the above-mentioned failure had been completed, task processor 605 would have deleted the pending task so process controller 601 does not retrieve the same task again. If the pending task failed, then the task would not have been deleted, and is retrieved and processed. Now turning to describe the lock feature in more detail, as noted above, a job is an instance of a workflow script and more than one instance of a workflow may be executed simultaneously. Further, each of the more than one instances of a workflow script may include the tasks to be executed. In order to prevent any task from being executed more than once simultaneously, at least some embodiments of the present invention includes a job/task lock feature as discussed above. More specifically, once a lock for a specific task of a specific job is established, the same task cannot be executed at the same time. Exemplary operations of the lock feature is described in connection with FIGS. 7 and 8 and in connection with an LR service. FIG. 7 depicts the steps involved in a successful locking procedure and FIG. 8 depicts the steps involved in an unsuccessful locking procedure. It should be noted that this lock feature can also be used with SR services as well.

Referring to FIG. 7, external service provider 607 makes an LR call (step 701) to task processor 605. Task processor 605 then attempts to lock the requested job/task (step 703). When it successfully locks the task (step 705), it creates a pending task, updates job context (e.g., including a designation that the lock was successful) and writes job listing to database 205 (step 707). Task processor 605 then generates (step 709) a new task_id for the task and broadcasts it to process controller 601. An acknowledgement is then made to external service provider 607 (step 711).

Referring to FIG. 8, external service provider 607 makes an LR call (step 801) to task processor 605. Task processor 605 then attempts to lock the requested task (step 803). When it fails to successfully lock the task (step 805), it updates job context (e.g., including a designation that the lock failed and a return address of the external service that failed to be executed to database 205 (step 805). An acknowledgement (e.g., an error message) is then made to external service provider (step 807).

Now turning to describe spitting a job mentioned earlier, when task processor 605 receives a pre-defined split instruction, it will: read the current job for an update; create pseudo jobs; mark status as pending; await an LR task completion for all the pseudo jobs. A flag is stored in database 205 to distinguish between regular and pseudo jobs. A job keeps track of the list of pseudo jobs. All pseudo jobs share the same job context. The split instruction is useful in the case where a lot is to be split. In this case, the job is copied in it's entirety, including pseudo jobs, context, etc. History may not be copied to pseudo job, however.

In another aspect of at least some embodiments of the present invention, the above described execution GUI in connection with the selection step (step 307), is also configured to display the status of tasks as they are being executed. For instance, the execution GUI is configured to show the status of the external service being executed (e.g., lock successful, parameters used, etc.), the status of the equipment that the external service is performing the task called by the job, the status of the material (e.g., a lot of wafers) being processed by the overall job and/or the logic associated with step being executed. After the completion of the tasks, the execution GUI may also display the history stored in database 205.

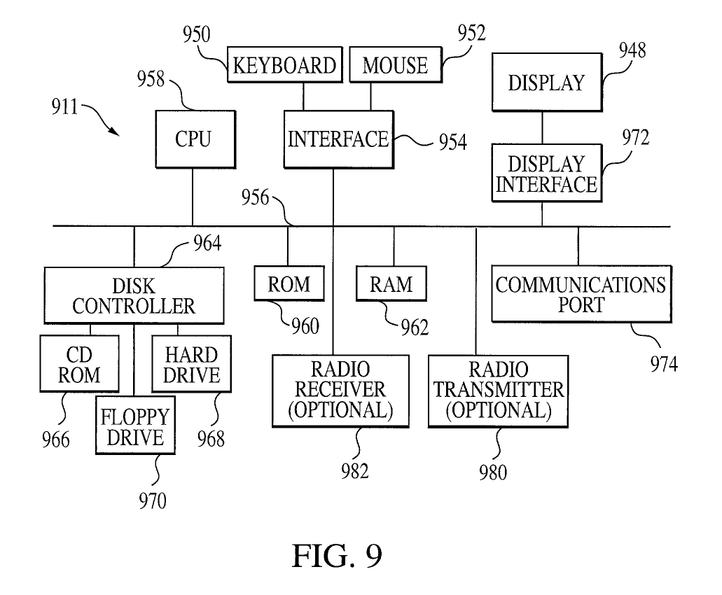

FIG. 9 illustrates a block diagram of one example of the internal hardware of a computer system 911 that is part of the present invention and/or part of the environment in which it operates, and that can include the workflow software component. A bus 956 serves as the main information highway interconnecting the other components of system 911. CPU 958 is the central processing unit of the system, performing calculations and logic operations required to execute the processes of embodiments of the present invention as well as other programs. Read only memory (ROM) 960 and random access memory (RAM) 962 constitute the main memory of the system. Disk controller 964 interfaces one or more disk drives to the system bus 956. These disk drives are, for example, floppy disk drives 970, or CD ROM or DVD (digital video disks) drives 966, or internal or external hard drives 968. These various disk drives and disk controllers are optional devices.

A display interface 972 interfaces display 948 and permits information from the bus 956 to be displayed on display 948. Display 948 can be used in displaying a graphical user interface (e.g., GUI 401). Communications with external devices such as the other components of the system described above can occur utilizing, for example, communication port 974. Optical fibers and/or electrical cables and/or conductors and/or optical communication (e.g., infrared, and the like) and/or wireless communication (e.g., radio frequency (RF), and the like) can be used as the transport medium between the external devices and communication port 974. Peripheral interface 956 interfaces the keyboard 950 and mouse 952, permitting input data to be transmitted to bus 956. In addition to these components, system 911 also optionally includes an infrared transmitter and/or infrared receiver. Infrared transmitters are optionally utilized when the computer system is used in conjunction with one or more of the processing components/stations that transmits/receives data via infrared signal transmission. Instead of utilizing an infrared transmitter or infrared receiver, the computer system may also optionally use a low power radio transmitter 980 and/or a low power radio receiver 982. The low power radio transmitter transmits the signal for reception by components of the production process, and receives signals from the components via the low power radio receiver. The low power radio transmitter and/or receiver are standard devices in industry.

Although system 911 in FIG. 9 is illustrated having a single processor, a single hard disk drive and a single local memory, system 911 is optionally suitably equipped with any multitude or combination of processors or storage devices. For example, system 911 may be replaced by, or combined with, any suitable processing system operative in accordance with the principles of embodiments of the present invention, including sophisticated calculators, and hand-held, laptop/notebook, mini, mainframe and super computers, as well as processing system network combinations of the same.

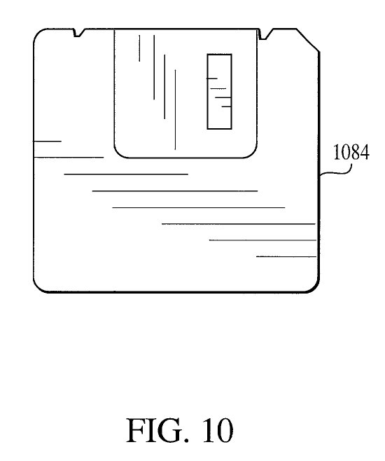

FIG. 10 is an illustration of an exemplary computer readable memory medium 1084 utilizable for storing computer readable code or instructions. As one example, medium 1084 may be used with disk drives illustrated in FIG. 9. Typically, memory media such as floppy disks, or a CD ROM, or a digital video disk will contain, for example, a multi-byte locale for a single byte language and the program information for controlling the above system to enable the computer to perform the functions described herein. Alternatively, ROM 960 and/or RAM 962 illustrated in FIG. 9 can also be used to store the program information that is used to instruct the central processing unit 958 to perform the operations associated with the instant processes. Other examples of suitable computer readable media for storing information include magnetic, electronic, or optical (including holographic) storage, some combination thereof, etc. In addition, at least some embodiments of the present invention contemplate that the medium can be in the form of a transmission (e.g., digital or propagated signals).

The above described features of the workflow software component (e.g., error handling and retry features) allow, in at least some embodiments of the present invention, that a task is executed once and only once. This one time execution feature can be viewed as a guarantee to any manufacturing facilities, using the at least some embodiments of the present invention, that a task will be executed only once even when there are faults (e.g., power supply shortage).

In general, it should be emphasized that the various components of embodiments of the present invention can be implemented in hardware, software or a combination thereof. In such embodiments, the various components and steps would be implemented in hardware and/or software to perform the functions of embodiments of the present invention. Any presently available or future developed computer software language and/or hardware components can be employed in such embodiments of the present invention. For example, at least some of the functionality mentioned above could be implemented using Visual Basic, C, C++, or any assembly language appropriate in view of the processor(s) being used. It could also be written in an interpretive environment such as Java and transported to multiple destinations to various users.

The many features and advantages of embodiments of the present invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A workflow system comprising:
a computer having at least one central processing unit (CPU);
a computer memory and/or storage, residing within said computer; and
a workflow software component, residing at least in part within said computer memory and/or storage, the workflow software component configured to execute a plurality of tasks to be performed automatically and configured to retry, for a predetermined number of times, to execute one of the plurality of tasks when said one of the plurality of tasks fails to be executed.

2. The system of claim 1, wherein the workflow software component is configured to process at least one short running service request among the plurality of tasks to be executed automatically, wherein the at least one short running service request is executed as a synchronous service.

3. The system of claim 1, wherein the workflow software component is configured to process at least one long running service request among the plurality of tasks to be executed automatically, wherein the at least one long running service request is executed as an asynchronous service.

4. The system of claim 1, wherein the predetermined number of times for said retry is equal to five.

5. The system of claim 1, wherein a first time interval between a first and a second retry is different from a second time interval between the second and a third retry.

6. The system of claim 1, wherein a time interval between a first and a second retry is shorter in duration than between any subsequent two consecutive retries.

7. The system of claim 1, wherein the workflow software component is configured to provide a standard software interface, thereby allowing an external software component to communicate therewith.

8. The system of claim 7, wherein the standard software interface complies with Component Object Model (COM).

9. The system of claim 1, wherein the workflow software component is further configured to commit a predetermined number of said plurality of tasks to be executed as a group.

10. A workflow system comprising:
a computer having at least one central processing unit (CPU);
a computer memory and/or storage, residing within said computer; and
a workflow software component, residing at least in part within said computer memory and/or storage, the workflow software component configured to execute a plurality of tasks to be performed automatically, wherein the workflow software component comprises:
a service provider configured to interface with at least one software object configured to carry out an instruction;
a task processor configured to execute the plurality of tasks by communicating with the at least one software object via the service provider; and
a process controller coupled to the task processor and configured to make a request to retry to execute one of the plurality of tasks when said one of the plurality of tasks fails to be executed by said task processor.

11. The system of claim 10, wherein the task processor is configured to attempt to lock another one of the plurality of tasks before said another one of the plurality of tasks is to be executed.

12. The system of claim 11, wherein the task processor is further configured to ensure that said another one of the plurality of tasks is not currently being executed when the task processor attempts lock the another one of the plurality of tasks.

13. The system of claim 10, further comprising:
a task initiator configured to make a request to the task processor to execute another one of the plurality of tasks, wherein the task processor executes said another one of the plurality of tasks in response to the request.

14. The system of claim 13, wherein the task initiator is further configured to retry to make the request to the task processor to execute the another one of the plurality of tasks when the task processor fails to executed the another one of plurality of tasks fails to be executed.

15. The system of claim 13, wherein the task controller is configured to make a request to the task initiator so that the another one of the plurality of tasks is executed by the task processor.

16. The system of claim 15, wherein the task processor is further configured to retry to make the request to the task initiator to execute the another one of the plurality of tasks when the another one of plurality of tasks fails to be executed.

17. The system of claim 10, wherein the instruction to be carried out by the service provider is to etch a lot of wafers.

18. The system of claim 10, wherein the workflow software component is configured to comply with Component Object Model (COM) objects.

19. The system of claim 10, wherein at least one of the plurality of tasks is a short running service having no return address in its Application Program Interface (API).

20. The system of claim 10, wherein at least one of the plurality of tasks is a long running service having a return address in its API, to thereby allow return information from the long running service is received by the return address.

21. The system of claim 20, wherein system resources are freed after the long running service has been called without waiting for the return information.

22. A workflow system comprising:
a computer having at least one central processing unit (CPU);
a computer memory and/or storage, residing within said computer; and
a workflow software means, residing at least in part within said computer memory and/or storage, the workflow software means configured to execute a plurality of tasks to be performed automatically, wherein the workflow software means comprises:
a service provider means for interfacing with at least one software object configured to carryout an instruction;
a task processor means for executing the plurality of tasks by communicating with the at least one software object via the service provider means; and
a process controller means for making a request to retry to execute one of the plurality of tasks when said one of the plurality of tasks fails to be executed by said task processor.

23. The system of claim 22, wherein the task processor means is configured to attempt to lock another one of the plurality of tasks before said another one of the plurality of tasks is to be executed.

24. The system of claim 23, wherein the task processor means is further configured to ensure that said another one of the plurality of tasks is not currently being executed when the task processor means attempts lock the another one of the plurality of tasks.

25. The system of claim 22, further comprising:
a task initiator means for making a request to the task processor means to execute another one of the plurality of tasks, wherein the task processor means executes said another one of the plurality of tasks in response to the request.

26. The system of claim 25, wherein the task initiator means is further configured to retry to make the request to the task processor means to execute the another one of the plurality of tasks when the task processor means fails to executed the another one of plurality of tasks fails to be executed.

27. The system of claim 25, wherein the task controller means for making a request to the task initiator means so that the another one of the plurality of tasks is executed by the task processor means.

28. The system of claim 27, wherein the task processor means is further configured to retry to make the request to the task initiator means to execute the another one of the plurality of tasks when the another one of plurality of tasks fails to be executed.

29. The system of claim 22, wherein the instruction to be carried out by the service provider means is to etch a lot of wafers.

30. The system of claim 22, wherein the workflow software means is configured to comply with Component Object Model (COM) objects.

31. The system of claim 22, wherein at least one of the plurality of tasks is a short running service having no return address in its Application Program Interface (API).

32. The system of claim 22, wherein at least one of the plurality of tasks is a long running service having a return address in its API, to thereby allow return information from the long running service to be received by the return address.

33. The system of claim 32, wherein system resources are freed after the long running service has been called without waiting for the return information.

34. A workflow method comprising the steps of:
(1) receiving a workflow script that includes a plurality of tasks configured to manufacture a product;
(2) automatically executing the plurality of tasks as defined in the workflow script; and
(3) retrying, for a predetermined number of times, to execute one of the plurality of tasks when the one of the plurality of tasks failed to be executed.

35. The method of claim 34, wherein the plurality of tasks of said step (1) comprises the step of including at least one short running service request, and wherein the method further comprises the step of:
synchronously executing the at least one short running service request.

36. The method of claim 34, wherein the plurality of tasks of said step (1) comprises the step of including at least one long running service request and wherein the method further comprises the step of:
asynchronously executing the at least one long running service request.

37. The method of claim 34, wherein said step (3) comprises the step of:
retrying at least five times when the one of the plurality of tasks continue to fail to be executed.

38. The method of claim 34, wherein said step (3) comprises the step of:
configuring a first time interval between a first and a second retry to be different from a second time interval between the second and a third retry.

39. The method of claim 34, wherein the retrying step includes the step of:
configuring a time interval between a first and a second retry to be shorter than between any subsequent two consecutive retries.

40. The method of claim 34, further comprising the step of:
committing a predetermine number of the plurality of tasks to be executed as a group.

41. A computer readable medium including instructions being executed by a computer, the instructions instructing the computer to create and use a computer-implemented workflow, the instructions comprising implementation of the steps of:
(1) receiving a workflow script that includes a plurality of tasks configured to manufacture a product;
(2) automatically executing the plurality of tasks as defined in the workflow script; and
(3) retrying, for a predetermined number of times, to execute one of the plurality of tasks when the one of the plurality of tasks failed to be executed.

42. The medium of claim 41, wherein the plurality of tasks of said step (1) comprises the step of including at least one short running service and wherein the method further comprises the step of:
synchronously executing the at least one short running service request.

43. The medium of claim 41, wherein the plurality of tasks of said step (1) comprises the step of including at least one long running service request and wherein the method further comprises the step of:
asynchronously executing the at least one long running service request.

44. The medium of claim 41, wherein said step (3) includes the step of:
retrying at least five times when the one of the plurality of tasks continue to fail to be executed.

45. The medium of claim 41, wherein said step (3) includes the step of:
configuring a first time interval between a first and a second retry to be different from a second time interval between the second and a third retry.

46. The medium of claim 41, wherein said step (3) includes the step of:
configuring a time interval between a first and a second retry to be shorter than between any subsequent two consecutive retries

47. The medium of claim 41, further comprising the step of:
committing a predetermine number of the plurality of tasks to be executed as a group.

48. A workflow system comprising:
a computer having at least one central processing unit (CPU);
a computer memory and/or storage, residing within said computer; and
a workflow software component, residing at least in part within said computer memory and/or storage, the workflow software component configured to execute a plurality of tasks to be performed automatically and configured to retry, for a predetermined number of times, to execute one of the plurality of tasks when said one of the plurality of tasks fails to be executed,
wherein the workflow software component is configured to process at least one short running service request and at least one long running service among the plurality of tasks to be executed automatically, and
wherein the at least one short running service request is executed as a synchronous service and the at least one long running service request is executed as an asynchronous service.

49. A workflow system comprising:
a computer having at least one central processing unit (CPU);
a computer memory and/or storage, residing within said computer; and
a workflow software component, residing at least in part within said computer memory and/or storage, the workflow software component configured to execute a plurality of tasks to be performed automatically and configured to retry, for a predetermined number of times, to execute one of the plurality of tasks when said one of the plurality of tasks fails to be executed,
wherein a first time interval between a first and a second retry is different from a second time interval between the second and a third retry.

50. A workflow method comprising the steps of:
(1) receiving a workflow script that includes a plurality of tasks configured to manufacture a product, wherein
(i) synchronously executing at least one short running service request, wherein the plurality of tasks comprises the at least one short running service request; and
(ii) asynchronously executing at least one long running service request, wherein the plurality of tasks comprises the at least one long running service request;
(2) automatically executing the plurality of tasks as defined in the workflow script;
(3) retrying, for a predetermined number of times, to execute one of the plurality of tasks when the one of the plurality of tasks failed to be executed; and
(4) configuring a time interval between a first and a second retry to be shorter than between any subsequent two consecutive retries.
